(19) United States
(12) Patent Application Publication
(10) Pub. No.: US 2008/0002570 A1
(43) Pub. Date: Jan. 3, 2008

(54) Network redundancy method, and middle apparatus and upper apparatus for the network redundancy method

(75) Inventors: Takatsugu Kurokawa, Kawasaki (JP); Keiichi Furukawa, Kawasaki (JP); Yuichirou Chikamatsu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/643,973

(22) Filed: Dec. 22, 2006

(30) Foreign Application Priority Data
Jun. 28, 2006 (JP) 2006-178478

(51) Int. Cl. H04J 3/14; H04J 1/16

(52) U.S. Cl. 370/219; 370/244

(57) ABSTRACT

A redundancy method in a network including an upper switch apparatus, middle switch apparatuses connected to the upper switch apparatuses via transmission lines and lower switch apparatuses each being connected to the middle switch apparatuses via transmission lines is provided. In the redundancy method, the upper switch apparatus has link aggregation setting for the transmission lines connected to the middle switch apparatuses, and each lower switch apparatus has link aggregation setting for the transmission lines connected to the middle switch apparatuses, and the upper switch apparatus and one of the lower switch apparatuses switches a traffic route from a transmission line that is failed and that is connected to one of the middle switches to another transmission line for which link aggregation is set with respect to the failed transmission line.

### BACKGROUND OF THF INVENTION

1. Field of the Invention

The present invention relates to a redundancy technique for a network. More particularly, the present invention relates to a redundancy technique for a network including an upper switch apparatus, plural middle switch apparatuses and plural lower switch apparatuses.

2. Description of the Related Art

A switch apparatus such as a layer 2 switch (L2SW) and a layer 3 switch (L3SW) performs switching processes by performing MAC address learning, and provides Ethernet connection services by identifying and accommodating users using VLAN (Virtual LAN) capabilities.

As redundancy techniques for switch apparatuses and transmission lines, there are STP (spanning tree protocol) and LAG (link aggregation). The spanning tree protocol is standardized as IEEE802.1d, and the protocol is for solving a packet loop problem when configuring redundant transmission lines using switches.

In the spanning tree protocol, as shown in FIG. 1, BPDU (Bridge Protocol Data Unit) is sent/received between switch apparatuses 1 and 2 so that a port to be blocked is determined. Then, transmission of packets to the blocking port are controlled so that the packet loop is eliminated, and redundancy of apparatuses and transmission lines can be realized.

In the link aggregation, as shown in FIG. 2, switch apparatuses 5 and 6 are connected by plural links, more particularly, connected by equal to or more than two cables 7 and 8, for example. As a result, if a cable is failed so that it cannot be used, communications can be continued by using other normal cables. The link aggregation is standardized as IEEE802.3ad as a technique for protecting against physical failure of apparatuses and cables or as a technique for increasing speed of communications between switch apparatuses. In addition, the link aggregation has a capability for dispersing traffic between switches into plural links. By the way, the link aggregation is a technique for transmission line redundancy and for increasing speed, but is not used for apparatus redundancy conventionally.

As another redundancy technology for apparatuses and transmission lines, there are techniques based on proprietary technique of communication apparatus vendors. FIG. 3 shows an example of the technique. In the example, core switches 11 and 12 (Master/Slave) are duplexed, and edge switches 13-16 are connected to the core switches 11 and 12 like a mesh. The master and the slave (core switches 11 and 12) are switched by exchanging specific control packets between the core switches 11 and 12.

By the way, Japanese Laid-Open Patent Application No. 2005-175591 discloses a switching hub having an EoE (Ethernet over Ethernet) function and a redundant port function. When the switching hub detects that a failure occurs at a port, it sends a re-learning frame, from a port at which no failure occurs, for instructing another switching hub to re-learn address. When another switching hub receives the re-learning frame, relays the frame from other port, and re-learns an address from the re-learning frame.

In the case of the spanning tree protocol shown in FIG. 1, when a failure occurs in the transmission line 3, time necessary for performing switching is long (50 seconds, normally). In addition, packet transfer cannot be performed by the blocking port of the switch apparatus 2. Therefore, there is a problem in that resources cannot be utilized efficiently.

As to link aggregation shown in FIG. 2, since packets are always transmitted on the transmission lines 7 and 8, resources can be used efficiently. However, the ling aggregation can be used only between the two switch apparatuses 5 and 6. Thus, there is a problem in that the switch apparatus 9 cannot be used for redundancy by connecting the transmission line 8 to the switch 9, for example.

As to the proprietary redundancy technique, speed of switching operation is basically high. But, when the core switch 11 of the master performs packet transfer, the core switch 12 of the slave is in a standby status and does not perform packet transfer basically. Thus, there is a problem in that the resources cannot be used efficiently like the spanning tree protocol.

### SUMMARY OF THF INVENTION

An object of the present invention is to provide network redundancy techniques for realizing redundancy of switch apparatuses and for utilizing resources efficiently.

The object can be achieved by a redundancy method in a network including an upper switch apparatus, middle switch apparatuses connected to the upper switch apparatuses via transmission lines and lower switch apparatuses each being connected to the middle switch apparatuses via transmission lines,

wherein the upper switch apparatus has link aggregation setting for the transmission lines connected to the middle switch apparatuses, and each lower switch apparatus has link aggregation setting for the transmission lines connected to the middle switch apparatuses, and

the upper switch apparatus and one of the lower switch apparatuses switches a traffic route from a transmission line that is failed and that is connected to one of the middle switches to another transmission line for which link aggregation is set with respect to the failed transmission line.

According to the present invention, redundancy of switch apparatuses can be realized and resources can be used efficiently.

### BRIEF DESCRIPTION OF THE DRAWINGS

Other objects, features and advantages of the present invention will become more apparent from the following detailed description when read in conjunction with the accompanying drawings, in which:

FIG. 1 is a figure for explaining transmission line redundancy using conventional spanning tree protocol;

FIG. 2 is a figure for explaining transmission line redundancy using conventional link aggregation;

FIG. 3 is a figure for explaining another transmission line redundancy method;

FIG. 4 shows a basic configuration of a network according to an embodiment of the present invention;

FIG. 5 is a figure for explaining operation when a failure occurs according to an embodiment of the present invention;

FIG. 6 shows a block diagram of a first embodiment of the switch apparatus 23, 24;

FIG. 7 shows a network configuration diagram of the first embodiment of the present invention;

FIG. 8 shows a block diagram of a second embodiment of the switch apparatus 23, 24;

FIG. 9 shows a block diagram of the second embodiment of the ADM 21;

FIG. 10 shows a network configuration diagram of the second embodiment of the present invention;

FIG. 11 shows a block diagram of a third embodiment of the switch apparatus 23, 24;

FIG. 12 shows a block diagram of the third embodiment of the ADM 21;

FIG. 13 shows a network configuration diagram of the third embodiment of the present invention;

FIG. 14 shows a block diagram of a fourth embodiment of the switch apparatus 23, 24;

FIG. 15 shows a block diagram of the fourth embodiment of the ADM 21;

FIG. 16 shows a network configuration diagram of the fourth embodiment of the present invention;

FIG. 17 shows an operation sequence of the fourth embodiment of the present invention;

FIG. 18 shows an example of a MAC table 42 of the switch apparatus 23;

FIG. 19 shows an example of a VLAN table 34 of the switch apparatus 23;

FIG. 20A shows an example of a status report packet for reporting the MAC information and the VLAN information from the switch apparatus 23 to the ADM 21;

FIG. 20B shows “status” in the status report packet in detail;

FIG. 21 shows an example of a MAC table 47 of the ADM 21;

FIG. 22 shows an example of a VLAN table 36 of the ADM 21.

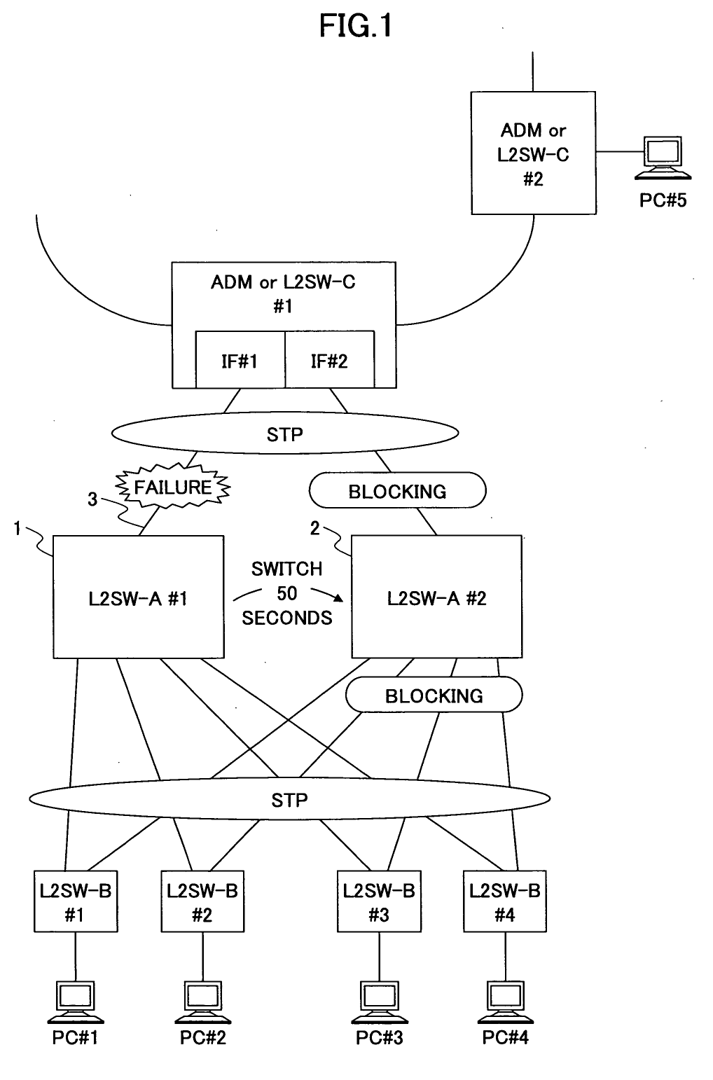

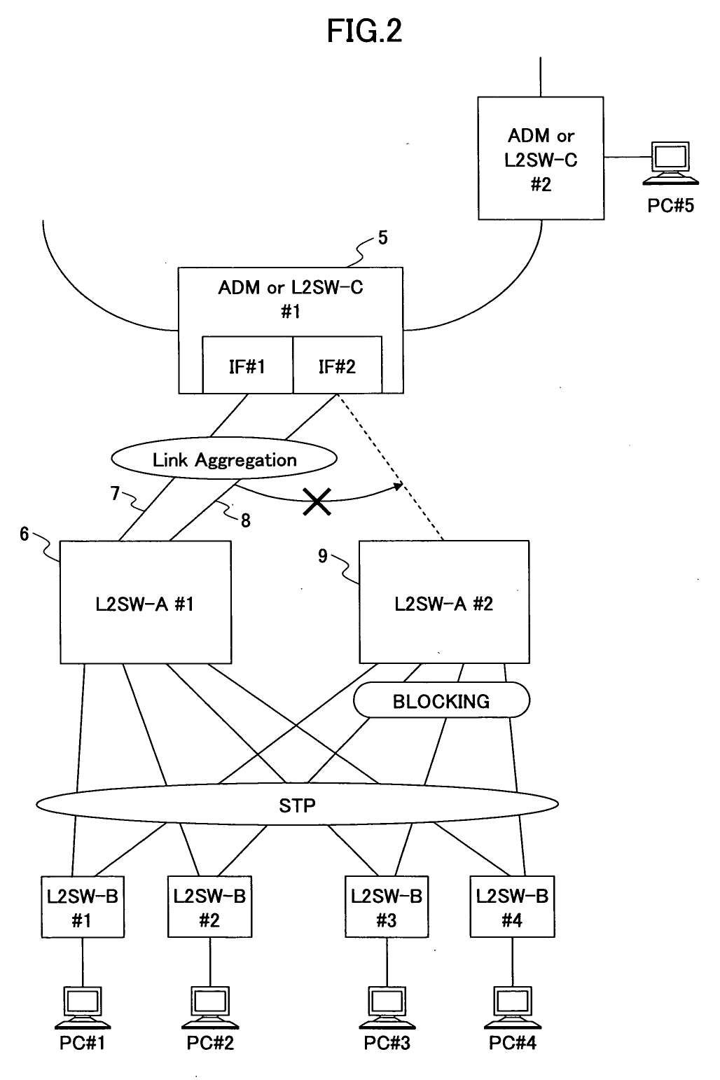

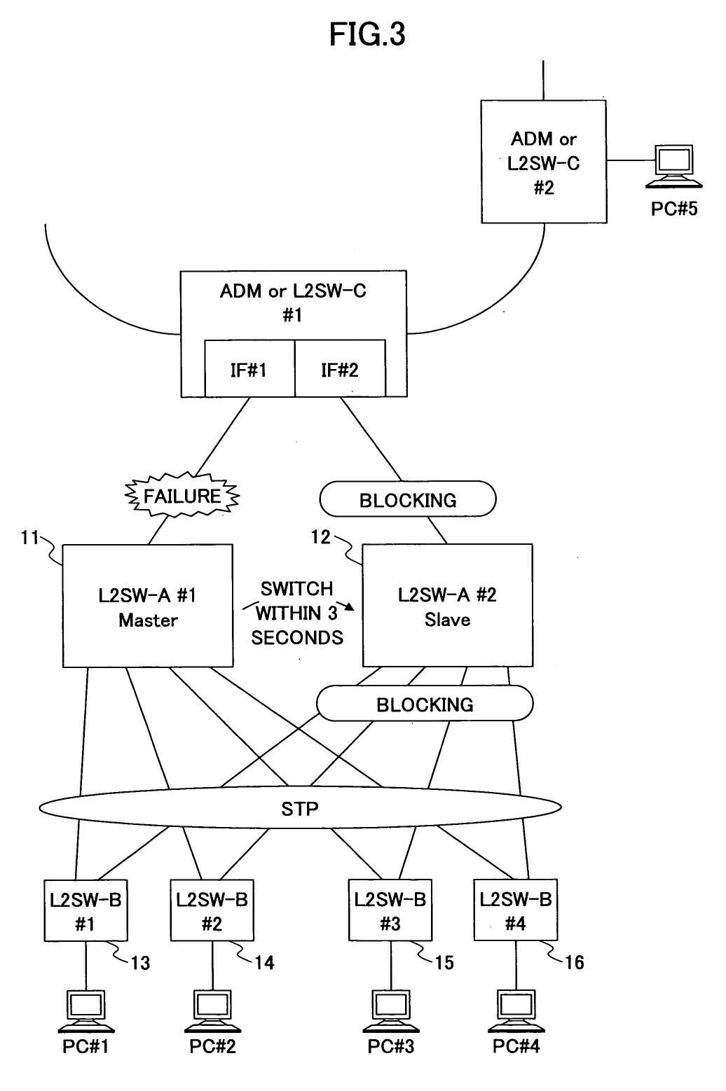

### DETAILED DESCRIPTION OF THE PREFERRED EMBODIMENTS

In the following, embodiments of the present invention are described with reference to figures.

<Basic Configuration of Network>

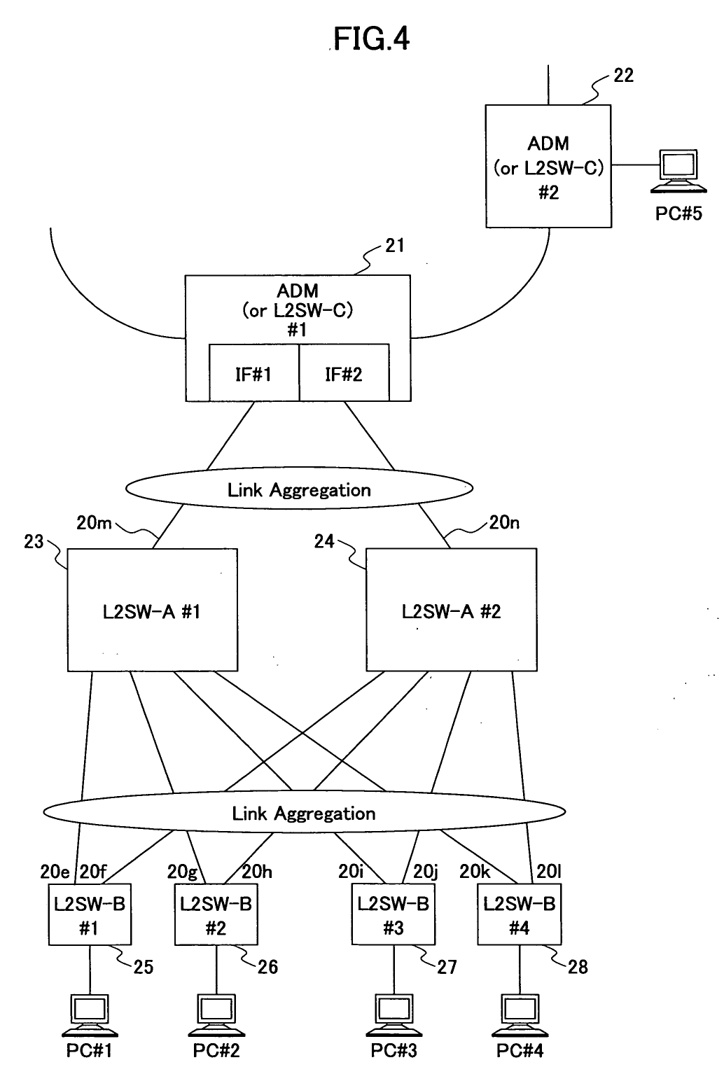

FIG. 4 shows a basic configuration of the network according to an embodiment of the present invention. As shown in the figure, the network includes ADMs (Add Drop Multiplexer) 21 and 22, and switch apparatuses 23-28 that are layer 2 switches, for example. Since the ADM 21 has a switch function, the ADM 21 is an upper switch apparatus. Each of the switches 23 and 24 (L2SW-A) is a middle switch apparatus, and each of the switch apparatuses 25-28 (L2SW-B) is a lower switch apparatus. By the way, instead of the ADM 21, a layer 2 switch similar to the switch apparatuses 23-28 can be used as the upper switch apparatus instead of the ADM 21.

Connection setting in the ADM 21 for the transmission lines 20m and 20n for connecting between the ADM 21 and the switch apparatuses 23 and 24 is the link aggregation. Also, link aggregation is set as connection setting in each of the switch apparatuses 25-28 for transmission lines to the switch apparatuses 23 and 24. Connection setting in each of the switches 23 and 24 is normal connection setting (no link aggregation) for the transmission lines 20m, 20n and 20e-20l.

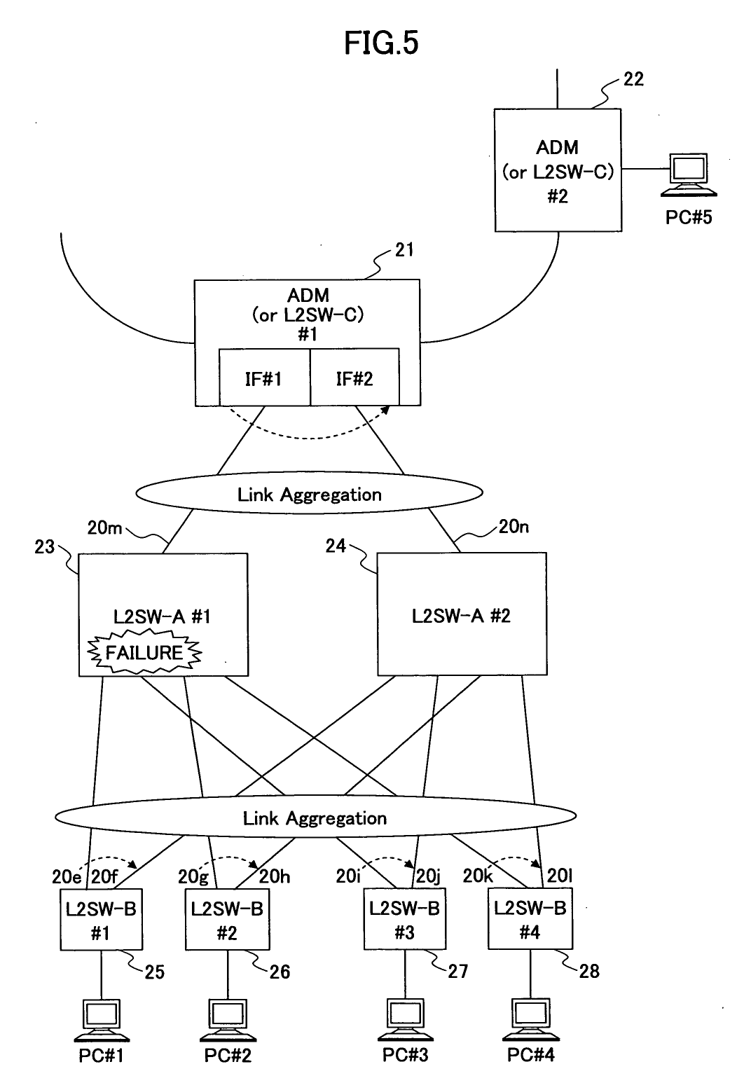

As shown in FIG. 5, for example, when a failure occurs in the switch apparatus 23, traffic handled by the switch apparatus 23 is taken over by the switch apparatus 24 by switching routes of the traffic from the transmission lines 20m, 20e, 20g, 20i and 20k that is connected to the switch apparatus 23 to transmission lines 20n, 20f, 20h, 20j and 201, so that apparatus redundancy can be realized. When there is no failure, all of the transmission lines 20e-20n can be used so that resources can be used efficiently.

### First Embodiment

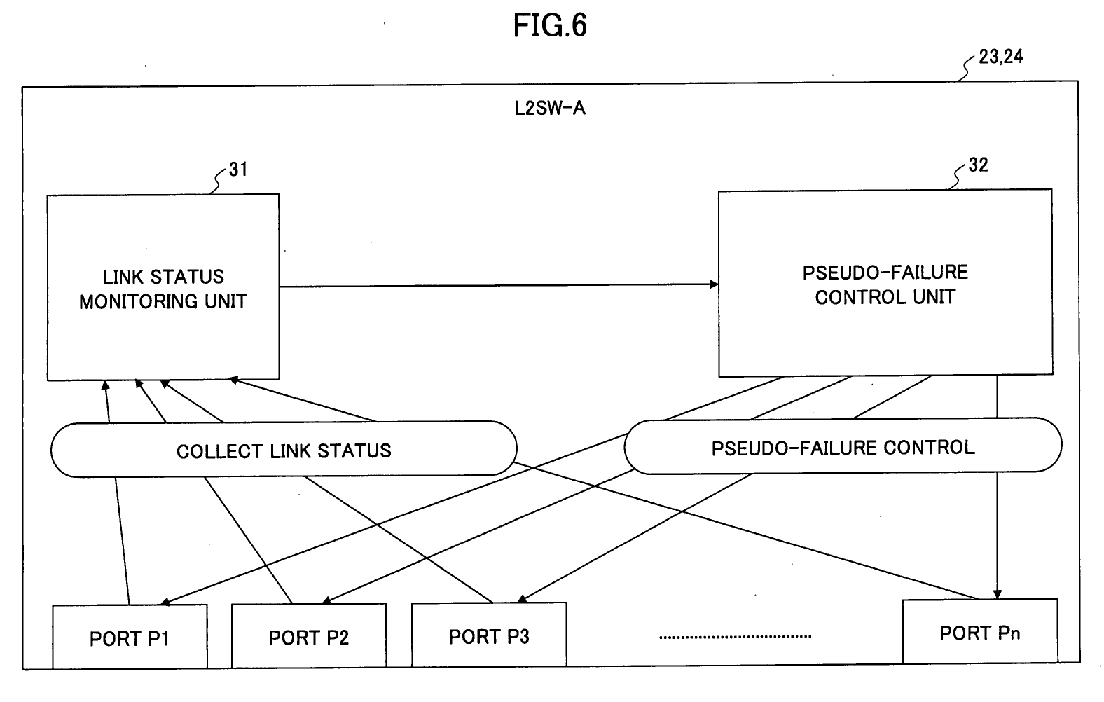

FIG. 6 shows a block diagram of a first embodiment of the switch apparatus (23 or 24). As shown in the figure, the switch apparatus includes a link status monitoring unit 31 and a pseudo-failure control unit 32. The link status monitoring unit 31 monitors status of ports P1-Pn. When the link status monitoring unit 31 detects a failure such as link disconnection, the link status monitoring unit 31 instructs the pseudo-failure control unit 32 to set ports other than a failure detected port into pseudo-failure status. The pseudo-failure control unit 32 temporarily sets auto negotiation into Disable (normally, it is Enable) to make apparatuses connected to the ports P1-Pn to perform link aggregation switching.

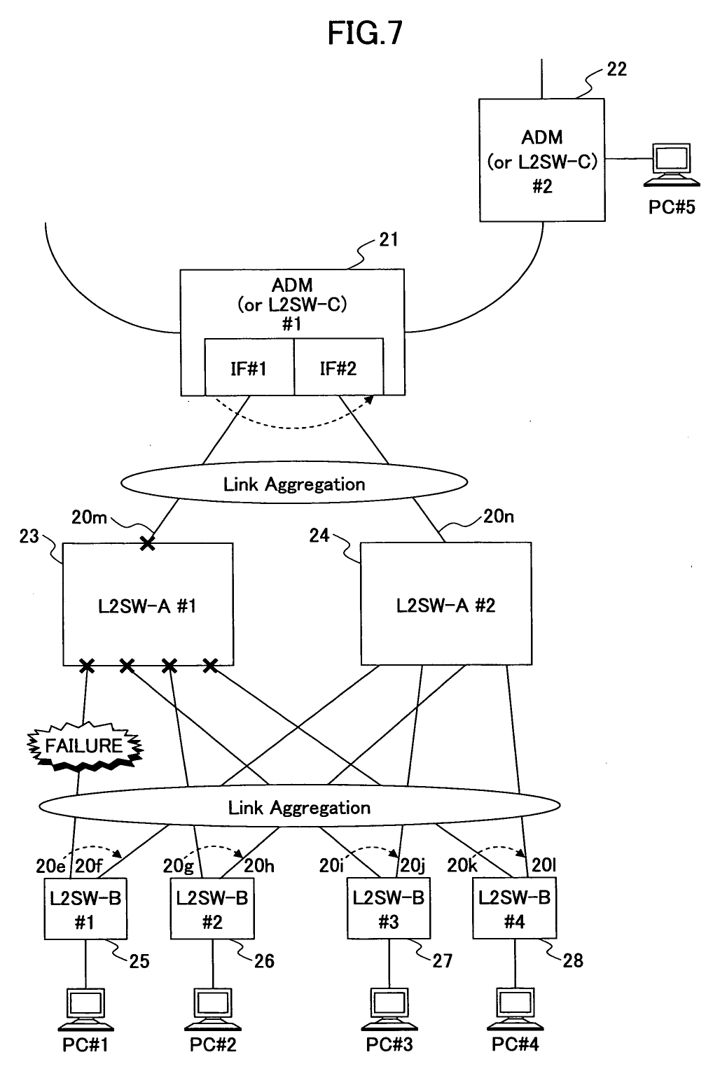

FIG. 7 shows a network configuration diagram of the first embodiment of the present invention. In the figure, same reference signs are assigned to same parts in FIG. 4. In FIG. 7, connection setting in the ADM 21 for the transmission lines 20m and 20n for connecting between the ADM 21 and the switch apparatuses 23 and 24 is the link aggregation. Also, link aggregation is set as connection setting in each of the switch apparatuses 25-28 for transmission lines to the switch apparatuses 23 and 24. Connection setting in each of the switches 23 and 24 is normal connection setting (no link aggregation) for the transmission lines 20m, 20n and 20e-20l.

For example, when a failure occurs in the transmission line 20e, the switch apparatus 25 connected to the transmission line 20e automatically switches a route of traffic transmitted over the transmission line 20e from the transmission line 20e to the transmission line 20f.

In the switch apparatus 23, the link status monitoring unit 31 detects the failure of the transmission line 20e at a port 20e, and the pseudo failure control unit 32 changes status of the transmission lines 20g, 20i, 20k and 20m into the pseudo-failure status.

Thus, the ADM 21 automatically switches a route of traffic transmitted by the transmission line 20m from the transmission line 20m to the transmission line 20n, and the switch apparatuses 26-28 automatically switch a route of traffic from the transmission lines 20g, 20i and 20k to the transmission lines 20h, 20j and 201 respectively. Accordingly, apparatus redundancy using the switch apparatuses 23 and 24 becomes available. When there is no failure, all of the transmission lines 20e-20n can be used so that resources can be used efficiently.

### Second Embodiment

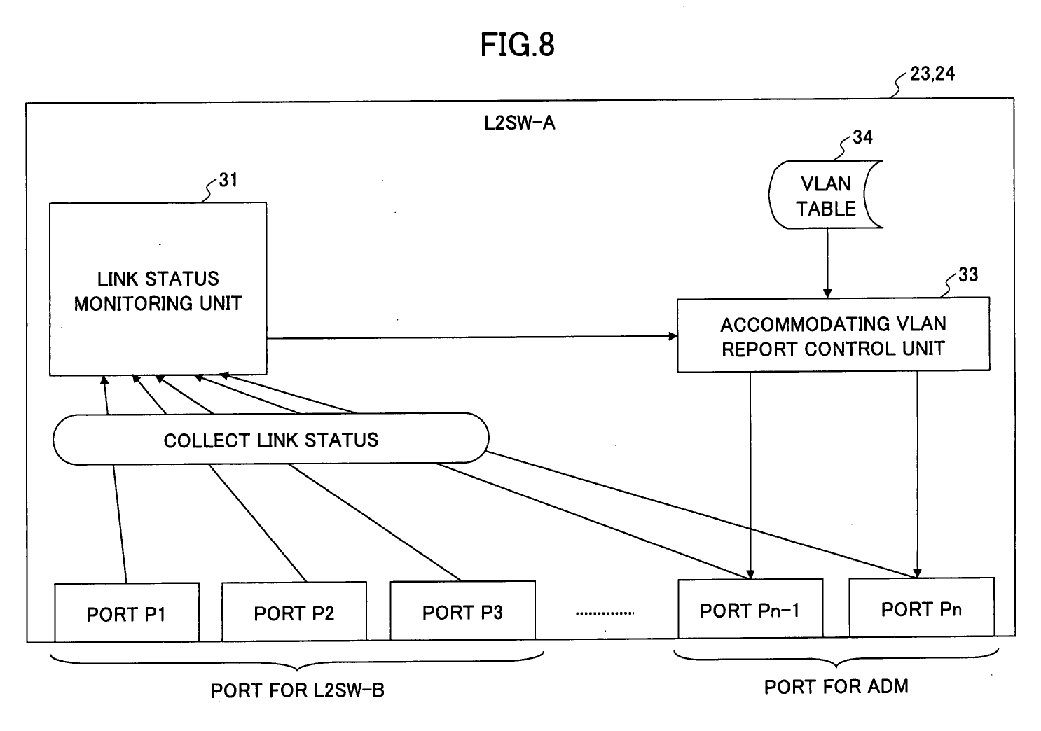

FIG. 8 shows a block diagram of the switch apparatus (23 or 24) in the second embodiment. As shown in the figure, the switch apparatus includes the link status monitoring unit 31, an accommodating VLAN report control unit 33 and a VLAN table 34. The link status monitoring unit 31 monitors status of ports P1-Pn. The VLAN table 34 holds information (VLANID: virtual network identifier) of VLANs accommodated by the ports P1, P2 and P3 for the switch apparatuses 25-28. When the link status monitoring unit 31 detects a link failure at a port of the ports P1, P2 and P3 for the switch apparatuses 25-28, the link status monitoring unit 31 reports a port at which the failure is detected to the accommodating VLAN report control unit 33.

The accommodating VLAN report control unit 33 searches the VLAN table 34 for information (link-failed VLAN information) of link-failed VLANs accommodated in the reported port, and the accommodating VLAN report control unit 33 sends the link-failed VLAN information to the ADM 21 via the port Pn-1 or Pn for the ADM 21.

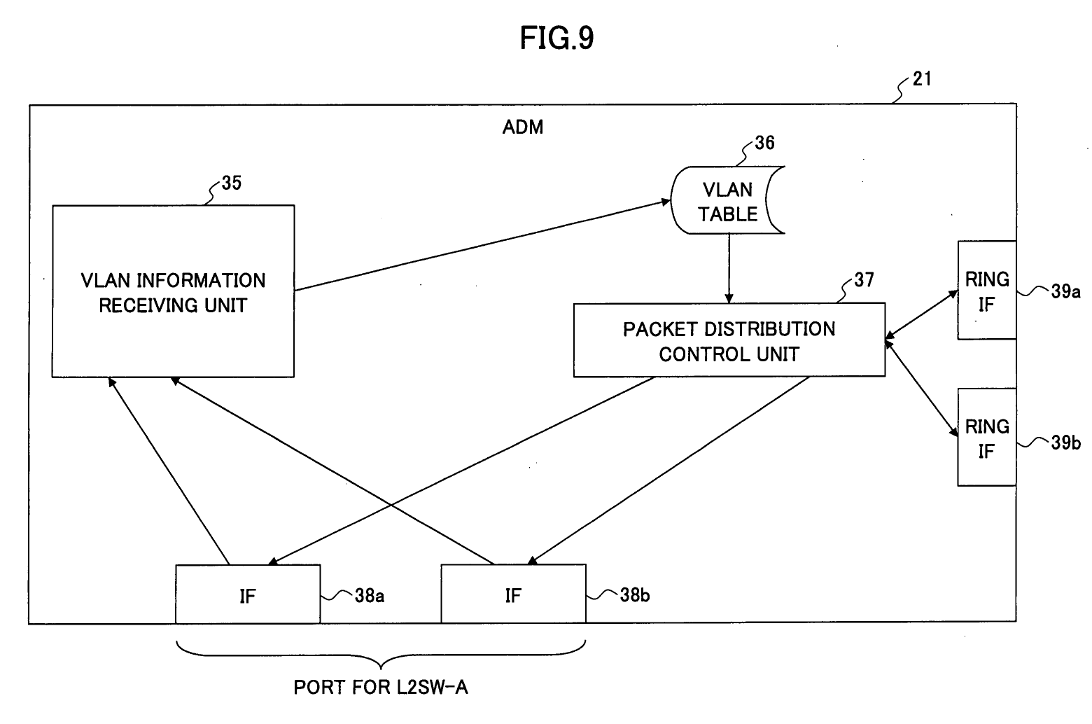

FIG. 9 is a block diagram showing the ADM 21 in the second embodiment. As shown in the figure, the ADM 21 includes a VLAN information receiving unit 35, a packet distribution control unit 37 and a VLAN table 36. When the VLAN information receiving unit 35 receives the link-failed VLAN information from the switch apparatus 23 or 24 via the transmission line 20m or 20n and via an interface 38a or 38b, the VLAN information receiving unit 35 adds a receiving port number that identifies the interface 38a or 38b by which the VLAN information is received to the received VLAN information and stores the VLAN information with the port number into the VLAN table 36. By the way, transmission lines of a ring network are connected to ring interfaces 39a and 39b.

The packet distribution control unit 37 refers to the VLAN table 36 so as to switch a transmission destination of packets belonging to a VLAN corresponding to the VLAN information from the interface 38a (or 38b) corresponding to the receiving port number to another interface 38b (or 38a).

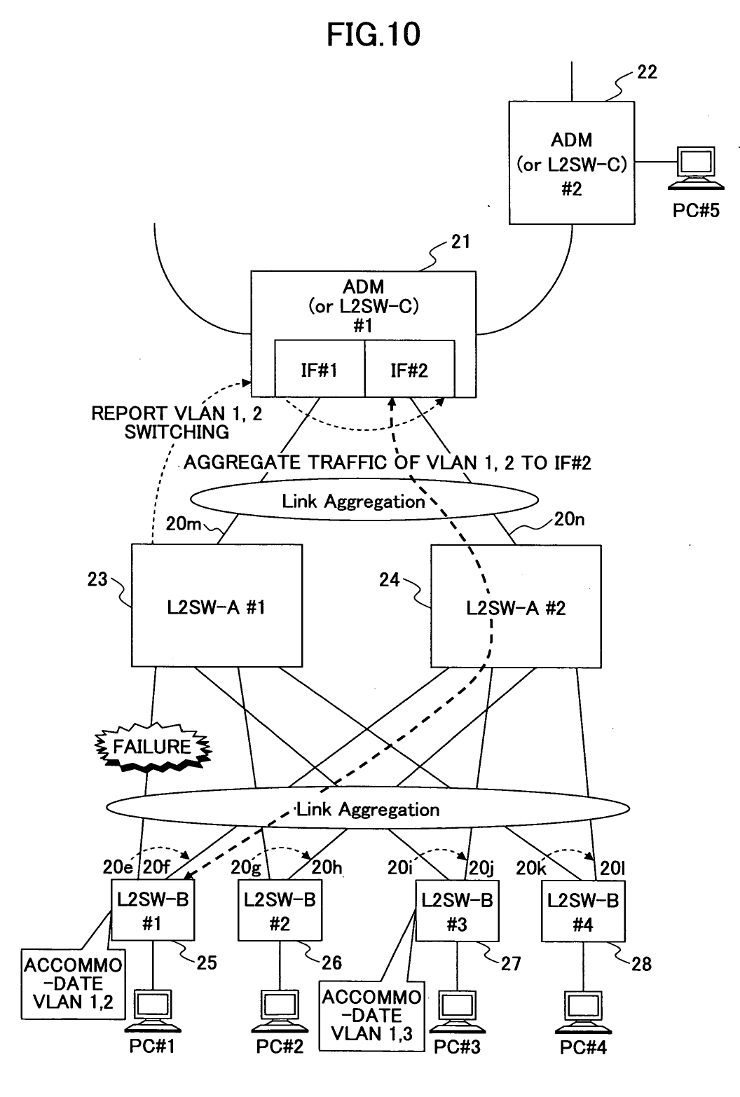

FIG. 10 is a network configuration diagram in the second embodiment of the present invention. In the figure, same reference signs are assigned to same parts in FIG. 4. In FIG. 10, connection setting in the ADM 21 for the transmission lines 20m and 20n for connecting between the ADM 21 and the switch apparatuses 23 and 24 is the link aggregation. Also, link aggregation is set as connection setting in each of the switch apparatuses 25-28 for transmission lines to the switch apparatuses 23 and 24. Connection setting in each of the switches 23 and 24 is normal connection setting (no link aggregation) for the transmission lines 20m, 20n and 20e-20l.

For example, when a failure occurs in the transmission line 20e, and when the switch apparatus 25 connected to the transmission line 20e accommodates VLANs 1 and 2 (VLANIDs=1 and 2 respectively), the switch apparatus 25 automatically switches a route of traffic transmitted through the transmission line 20e from the transmission line 20e to the transmission line 20f.

In the switch apparatus 23, when the link status monitoring unit 31 detects a failure of the transmission line 20e, the link status monitoring unit 31 refers to the VLAN table 36 so that the switch apparatus 23 reports VLAN information (VLANID=1, 2) of VLANs accommodated in the transmission line 20e to the ADM 21 as link-failed VLAN information.

The ADM 21 receives the VLAN information from the switch apparatus 23 via the interface 38a. Then, the ADM 21 aggregates traffic of the VLANs 1 and 2 corresponding to the VLAN information to the interface 38b. That is, the ADM 21 switches a route of the traffic of the VLANs 1 and 2 transmitted to the interface 38a from the route via the interface 38a to a route via the interface 38b. As a result, only the transfer route of the traffic of the VLANs 1 and 2 can be switched from the transmission lines 20m and 20e to the transmission lines 20n and 20f.

Assuming that the switch apparatus 27 accommodates VLANs 1 and 3 (VLANIDs=1, 3), a route of traffic of the VLAN 1 (VLANID=1) is switched from a route of the transmission lines 20m and 20i to a route of the transmission lines 20n and 20j, but traffic of VLAN 3 (VLANID=3) is transmitted over a route of the transmission lines 20m and 20i as before.

In this embodiment, since the transfer route is changed for each VLAN, load concentration of a changed destination route can be reduced compared with the case in which all traffic on the switch apparatus 23 is taken over by a route via the switch apparatus 24 as in the first embodiment. In addition, resources can be used efficiently by using all of the transmission lines 20e-20n.

### Third Embodiment

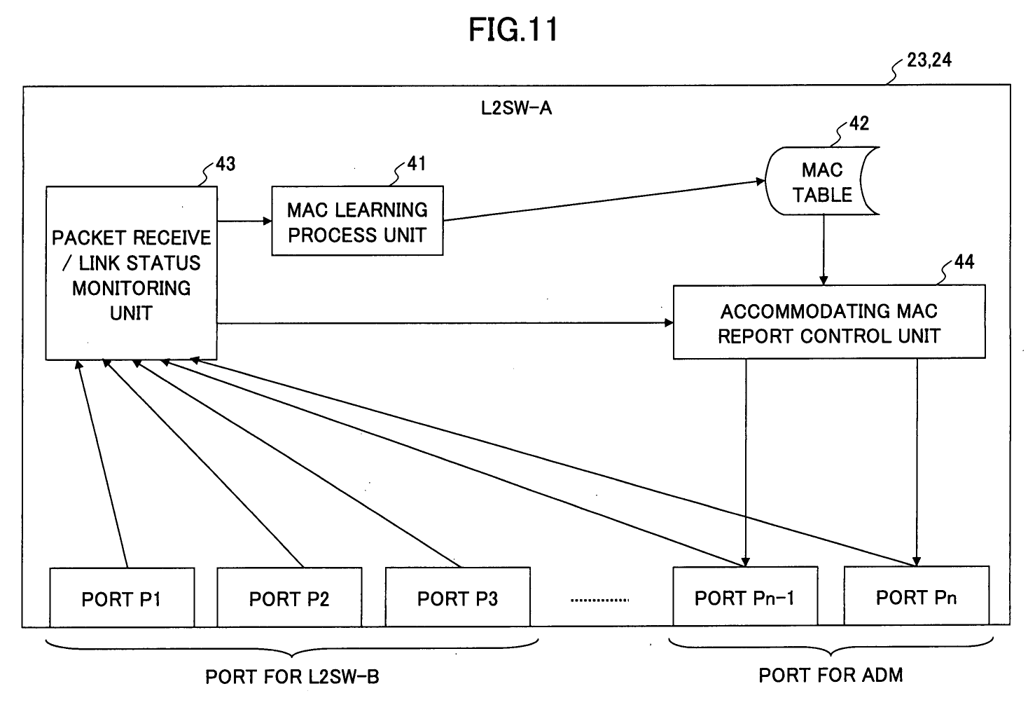

FIG. 11 is a block diagram of the switch apparatus (23 or 24) in the third embodiment. As shown in FIG. 11, the switch apparatus includes a MAC learning process unit 41, a MAC table 42, a packet receive/link status monitoring unit 43, and an accommodating MAC report control unit 44. The MAC learning process unit 41 performs normal MAC learning operation so as to add receive port information to a source MAC address (SA) of a received packet and register the source MAC address with the receive port information in the MAC table 42.

The packet receive/link status monitoring unit 43 monitors link status of the ports P1, P2 and P3 for the switch apparatuses 25-28. When the packet receive/link status monitoring unit 43 detects link failure, the packet receive/link status monitoring unit 43 sends information of a failed port to the accommodating MAC report control unit 44.

The accommodating MAC report control unit 44 searches the MAC table 42 for link-failed MAC information corresponding to the reported port information, and sends the search result to the ADM 21 from the ports Pn-1 or Pn for the ADM 21.

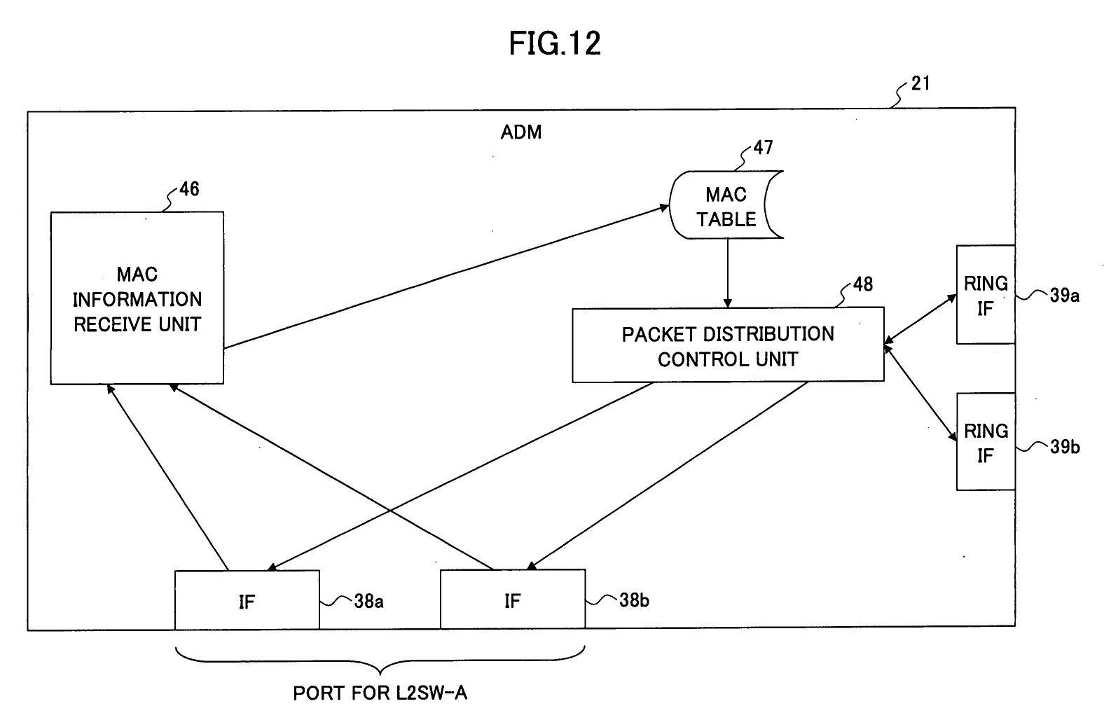

FIG. 12 is a block diagram of the ADM 21 in the third embodiment. As shown in the figure, the ADM 21 includes a MAC information receive unit 46, a MAC table 47, and a packet distribution control unit 48. When the MAC information receive unit 46 receives the link failed MAC information via the switch apparatus 23 or 24 and via the interface 38a or 38b, the MAC information receive unit 46 adds a receive port number identifying the interface 38a or 38b by which the link-failed MAC information is received to the received link-failed MAC information so as to store the MAC information with the receive port number into the MAC table 47.

The packet distribution control unit 48 refers to the MAC table 47 so as to switch a send destination interface of packets having a destination MAC address (DA) corresponding to the registered link-failed MAC information from the interface 38a (or 38b) corresponding to the receive port number to another interface 38b (or 38a), and changes send destination of multicast, broadcast and unlearned packets in the same way.

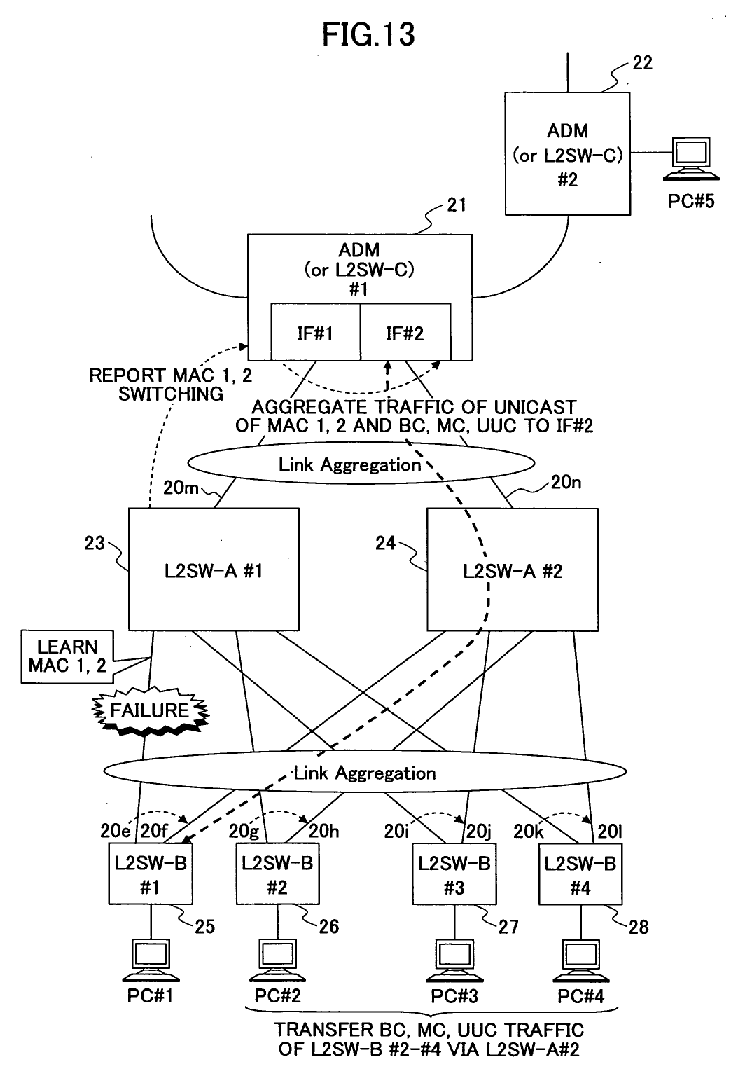

FIG. 13 is a network configuration diagram in the third embodiment of the present invention. In the figure, same reference signs are assigned to same parts in FIG. 4. In FIG. 13, connection setting in the ADM 21 for the transmission lines 20m and 20n for connecting between the ADM 21 and the switch apparatuses 23 and 24 is the link aggregation. Also, link aggregation is set as connection setting in each of the switch apparatuses 25-28 for transmission lines to the switch apparatuses 23 and 24. Connection setting in each of the switches 23 and 24 is normal connection setting (no link aggregation) for the transmission lines 20m, 20n and 20e-20l.

For example, when a failure occurs in the transmission line 20e, the switch apparatus 25 automatically changes a route of traffic transmitted through the transmission line 20e from the transmission line 20e to the transmission line 20f.

In the switch apparatus 23, when the packet receive/link status monitoring unit 43 detects a failure of the transmission line 20e, the accommodating MAC report control unit 44 reports MAC addresses (MAC 1 and MAC 2) learned on the transmission line 20e to the ADM 21 as link-failed MAC information.

The ADM 21 receives the link-failed MAC information from the switch apparatus 23. Then, the packet distribution control unit 48 aggregates packets having the MAC address corresponding to the link-failed MAC information as a destination MAC address (DA), multicast packets, broadcast packets and unlearned packets into the interface 38b. That is, the ADM 21 transfers traffic of MAC 1 and MAC 2 that was transferred to the interface 38a to the interface 38b.

As a result, a transfer route of the traffic of packets having the MAC addresses 1 and 2 as destination addresses, multicast packets, broadcast packets and unlearned packets is changed from the route via the switch apparatus 23 to the route via the switch apparatus 24.

In this embodiment, since transfer route can be switched for each MAC address, load concentration of a changed destination route can be reduced compared with the case in which all traffic on the switch apparatus 23 is changed to a route via the switch apparatus 24 as in the first embodiment. In addition, resources can be used efficiently by using all of the transmission lines 20e-20n.

### Forth Embodiment

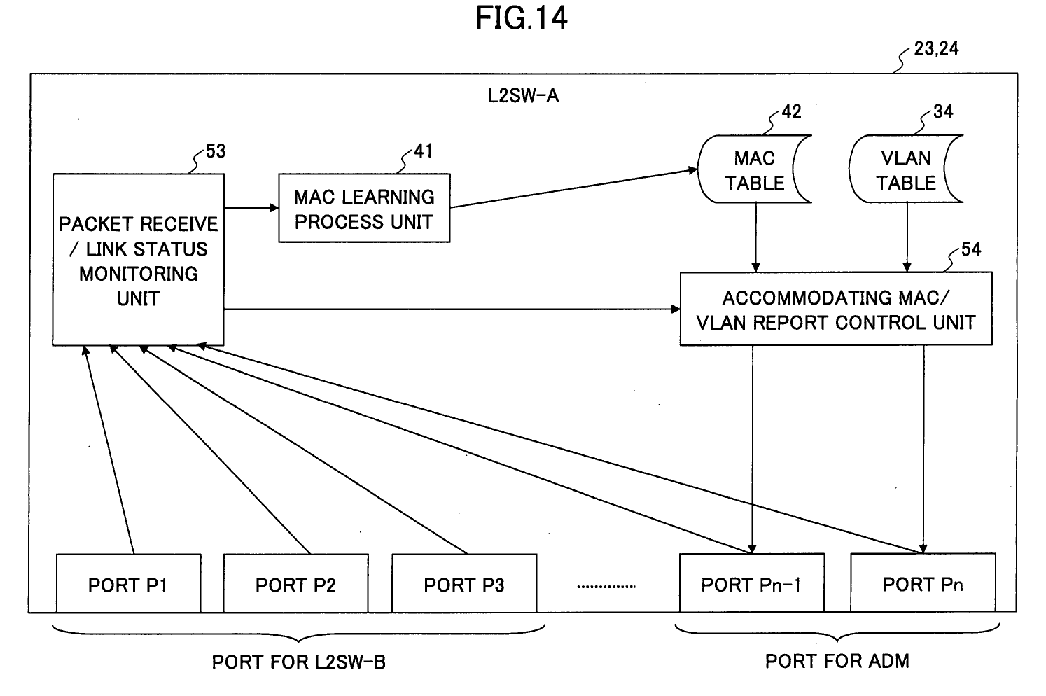

FIG. 14 shows a block diagram of the fourth embodiment of the switch apparatus 23 or 24. In the figure, same reference singes are assigned to same parts of FIG. 8 or FIG. 11.

In FIG. 14, the switch apparatus includes a packet receive/link status monitoring unit 53, an accommodating MAC/VLAN report control unit 54, a MAC learning process unit 41, a MAC table 42 and a VLAN table 34.

The packet receive/link status monitoring unit 53 monitors status of ports P1-Pn. When the packet receive/link status monitoring unit 53 detects link failure, the packet receive/link status monitoring unit 53 reports information of a failed port to the accommodating MAC/VLAN report control unit 54.

The VLAN table 34 holds information of VLANs accommodated in ports P1, P2 and P3 for the switch apparatus 25-28.

In addition, the MAC learning process unit 41 performs normal MAC learning operation, and adds receive port information to a source MAC address (SA) of a received packet and registers the source MAC address with the receive port information in the MAC table 42.

The accommodating MAC/VLAN report control unit 54 searches the VLAN table 34 for information (link-failed VLAN information) of a VLAN accommodated in a port from which the link failure is reported so as to send the link-failed VLAN information to the ADM 21 from the port Pn-1 or Pn, and searches the MAC table 42 for link-failed MAC information corresponding to the port (learned at the port) from which the link failure is reported, and sends the search results to the ADM 21 from the port Pn-1 or Pn.

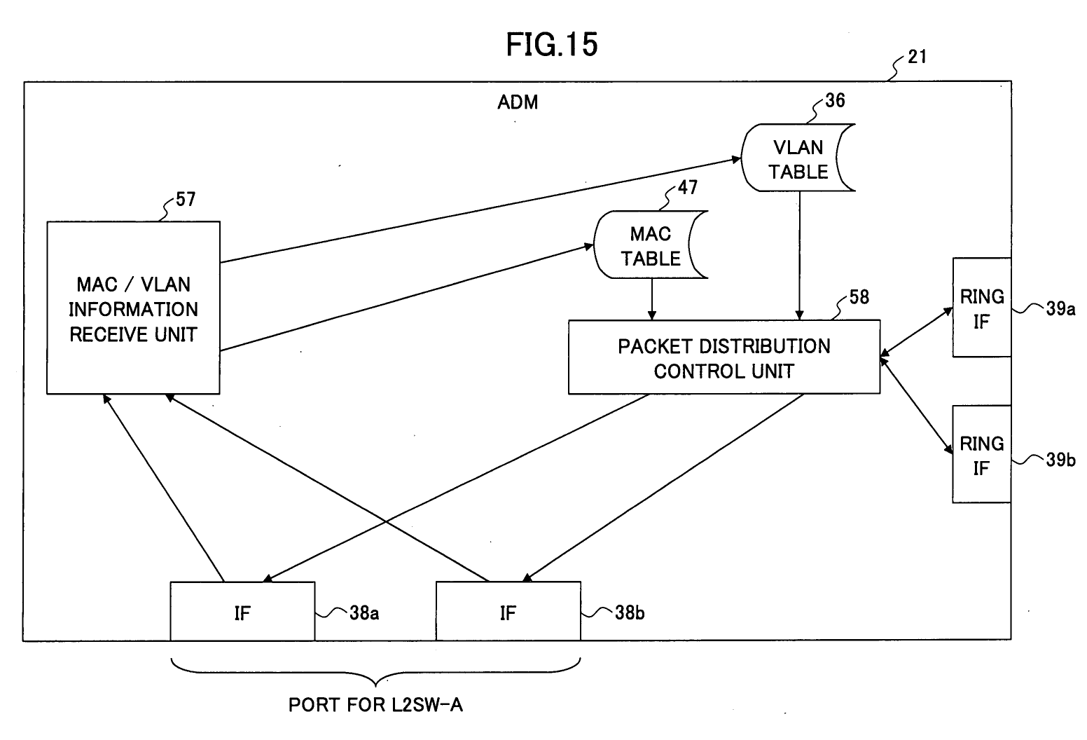

FIG. 15 is a block diagram of the ADM 21 in the fourth embodiment. In the figure, same reference sings are assigned to same parts in FIG. 9 or FIG. 12.

As shown in FIG. 15, the ADM 21 includes a MAC/VLAN information receive unit 57, a packet distribution control unit 58, a VLAN table 36 and a MAC table 47.

When the MAC/VLAN information receive unit 57 receives information of link-failed VLAN information from the switch apparatus 23 or 24 via the transmission line 20m or 20n and the interface 38a or 38b, the MAC/VLAN information receive unit 57 adds a receive port number for identifying the interface 38a or 38b to the received VLAN information and stores the VLAN information with the port number in the VLAN table 36. When the MAC/VLAN information receive unit 57 receives link-failed MAC information, the MAC/VLAN information receive unit 57 adds a receive port number for identifying the interface 38a or 38b to the received link-failed MAC information, and stores the MAC information with the port number in the MAC table 47. By the way, transmission lines of a ring network are connected to the ring interfaces 39a and 39b.

The packet distribution control unit 58 refers to the MAC table 47 so as to switch a transmission destination of packets having a destination MAC address (DA) corresponding to the registered link-failed MAC information from the interface 38a (or 38b) corresponding to the receive port number to another interface 38b (or 38a). In addition, the packet distribution control unit 58 refers to the VLAN table 36 so as to switch a transmission destination of multicast, broadcast and unlearned packets from the interface 38a (or 38b) corresponding to the receive port number to another interface 38b (or 38a).

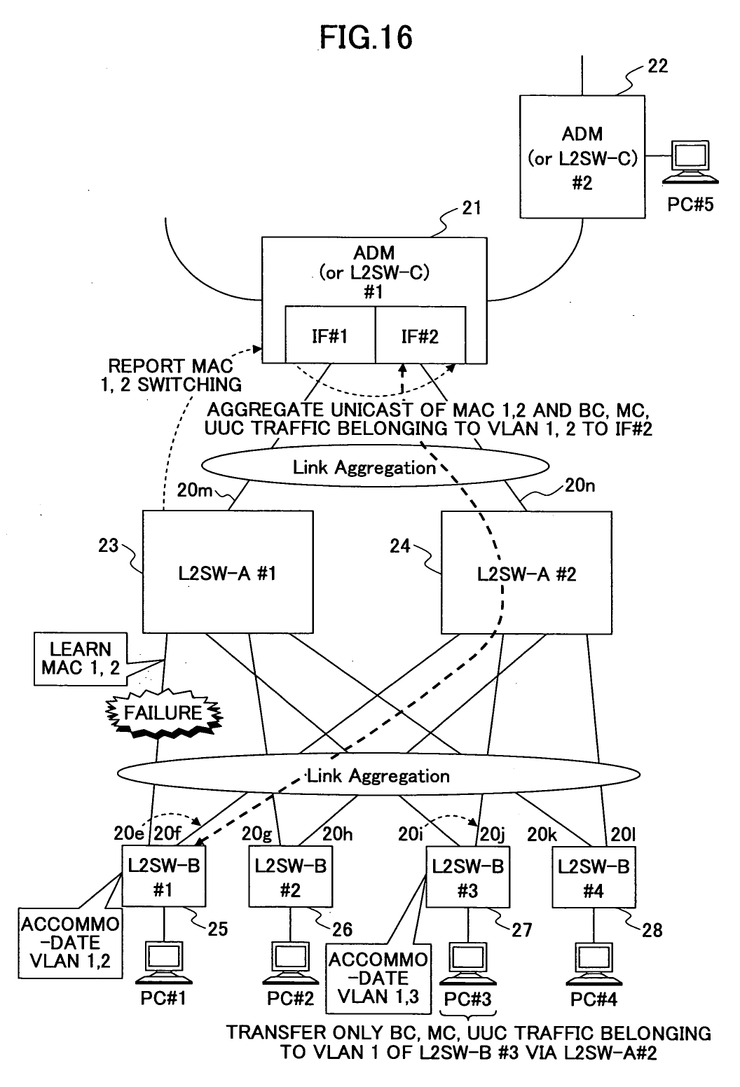

FIG. 16 is a network configuration diagram in the fourth embodiment of the present invention. In the figure, same reference signs are assigned to same parts in FIG. 4. In FIG. 16, connection setting in the ADM 21 for the transmission lines 20m and 20n for connecting between the ADM 21 and the switch apparatuses 23 and 24 is the link aggregation. Also, link aggregation is set as connection setting in each of the switch apparatuses 25-28 for transmission lines to the switch apparatuses 23 and 24. Connection setting in each of the switches 23 and 24 is normal connection setting (no link aggregation) for the transmission lines 20m, 20n and 20e-20l.

For example, when a failure occurs in the transmission line 20e, and when the switch apparatus 25 connected to the transmission line 20e accommodates VLANs 1 and 2 (VLANIDs=1 and 2 respectively), the switch apparatus 25 automatically switches a route of traffic transmitted through the transmission line 20e from the transmission line 20e to the transmission line 20f.

In the switch apparatus 23, the packet receive/link status monitoring unit 53 detects the failure of the transmission line 20e, the accommodating MAC/VLAN report control unit sends MAC addresses (MAC 1 and 2) learned on the transmission line 20e and information of VLANs (VLANID=1 and 2) accommodated in the transmission line 20e to the ADM 21 as link-failed MAC information and link-failed VLAN information.

The ADM 21 receives the link-failed MAC information and the link-failed VLAN information from the switch apparatus 23 via the interface 38a. Then, the ADM 21 aggregates, to the interface 38b, packets having a destination address corresponding to the reported link-failed MAC address 1 or 2, and multicast, broadcast and unlearned packets belonging to the reported link-failed VLANs 1 and 2. That is, traffic of packets having MAC addresses 1 and 2, and multicast, broadcast and unlearned packets having the VLANID 1 or 2 that was transferred via the interface 38a is switched to be transferred via the interface 38b.

As a result, a transmission route for traffic of packets having MAC addresses 1 and 2 as its destination address, and multicast, broadcast and unlearned packets belonging to VLANs 1 and 2 is changed from the route via the switch apparatus 23 to the route via the switch apparatus 24.

For example, assuming that the switch apparatus 27 accommodates VLANs (VLANIDs 1 and 3), traffic of multicast, broadcast and unlearned packets belonging to VLAN 1 (VLANID=1) are transmitted over the route of the transmission lines 20n and 20j, and unicast traffic of VLANID=1 and all traffic of VLANID=3 are transmitted via the route of the transmission lines 20m and 20i in the same way as before.

In this embodiment, since the transfer route is changed for each MAC and for each VLAN, load concentration of a changed destination route can be reduced compared with the case in which all traffic on the switch apparatus 23 is changed to a route via the switch apparatus 24 as in the first embodiment. In addition, resources can be used efficiently by using all of the transmission lines 20e-20n.

### <More Detailed Description for the Fourth Embodiment>

In FIG. 16, when a transmission line 20m between the ADM 21 and the switch apparatus 23 is failed, for example, communications are recovered by the method described with reference to FIG. 5. More particularly, the switch apparatus 23 sets the transmission lines 20e, 20g, 20i and 20k to be in the pseudo-failure status so that the switch apparatuses 25-28 switches the transmission lines 20e, 20g, 20i and 20k to link aggregated transmission lines 20f, 20h, 20j and 201 respectively, and the communication route is switched from the route of ADM 21—transmission line 20m—switch apparatus 23—transmission lines 20e, 20g, 20i and 20k—corresponding switch apparatuses 25-28 to the route of ADM 21—transmission line 20n—switch apparatus 24—transmission line 20f, 20h, 20j and 20l—corresponding switch apparatuses 25-28.

When the failure of the transmission line 20m is recovered, the switch apparatus 23 releases the pseudo-failure status for the transmission lines 20e, 20g, 20i and 20k so that the link aggregation transmission lines are recovered. As a result, the communication route is switched back from the route of ADM 21—transmission line 20n—switch apparatus 24, transmission lines 20f, 20h, 20j and 20l—corresponding switch apparatuses 25-28 to the route of ADM 21—transmission line 20m—switch apparatus 23—transmission lines 20e, 20g, 20i and 20k—corresponding switch apparatuses 25-28.

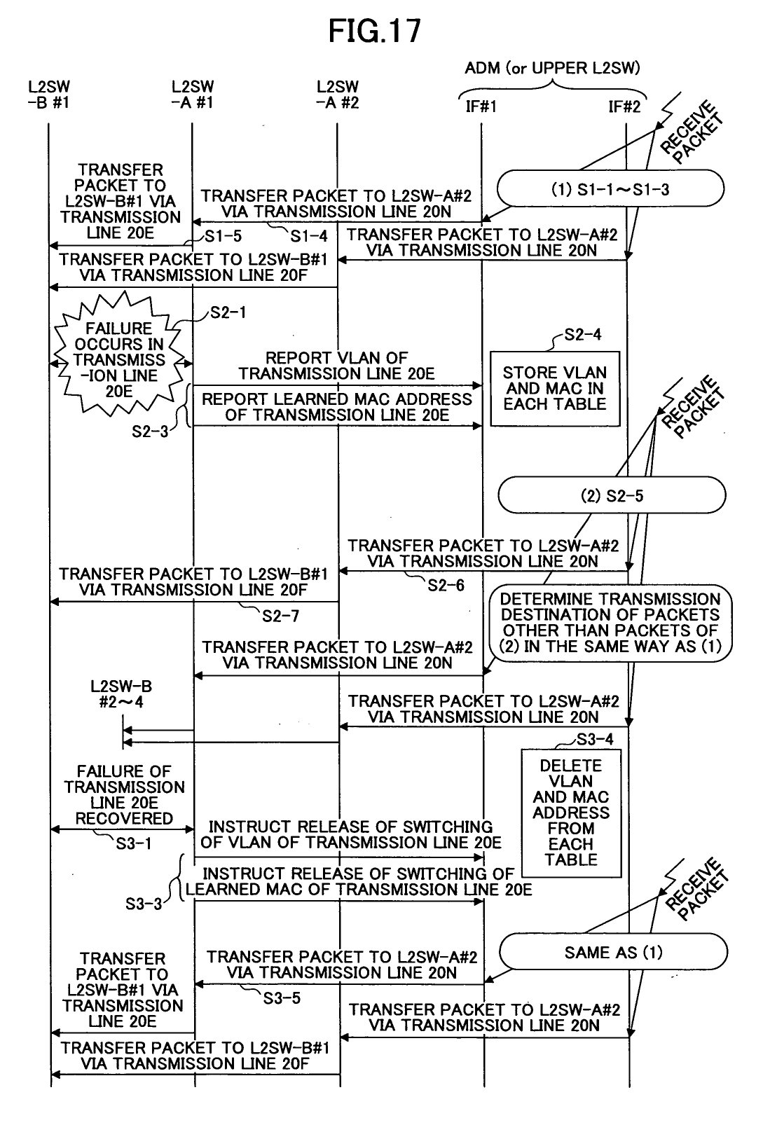

FIG. 17 shows an operation sequence of the fourth embodiment of the present invention. This sequence shows operation when the transmission line 20e between the switch apparatus 23 and the switch apparatus 25 is failed.

In a normal state, packet transfer is performed in the following procedure.

In step S1-1, the ADM 21 receives a packet from the ADM 22 in the ling network, for example.

In step S1-2, the ADM 21 performs hash calculation from a destination address (DA), a source address (SA) and an IP address and the like included in the received packet so as to determine a destination for sending the packet from the link aggregation transmission lines 20m and 20n (interfaces 38a and 38b).

In step S1-3, the ADM 21 sends the packet from an IF that is determined in step S1-2.

In step S1-4, the packet sent in step S1-3 is received by the switch apparatus 23 or 24.

In step S1-5, the switch apparatus that receives the packet transfer the packet based on learning result of the switch.

In step S1-6, the packet sent from the switch apparatus (23 or 24) in step S1-5 is received by the switch apparatus 25, for example, via the link aggregation transmission line 20e or 20f.

When the transmission line 20e is failed, packet transfer is performed in the following procedure.

In step S2-1, a failure occurs in the transmission line 20e.

In step S2-2, the switch apparatus that detects the failure of the transmission line 20e aggregates traffic for the transmission line 20e into the link aggregated transmission line 20f.

In step S2-3, the switch apparatus 23 that detects the failure of the transmission line 20e reports, to the ADM 21, MAC information of the MAC table 42 learned on the transmission line 20e and VLAN information of the VLAN table 34 of VLANs accommodated in the transmission line 20e.

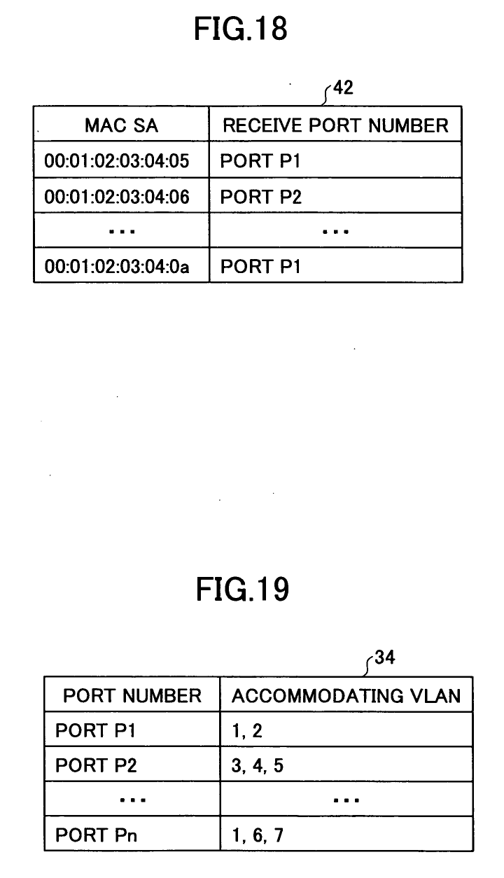

FIG. 18 shows an example of the MAC table 42 of the switch apparatus 23. The MAC table 42 registers a receive port number and a source MAC address (SA) of a received packet received by a port of the receive port number.

FIG. 19 shows an example of the VLAN table 34 of the switch apparatus 23. The VLAN table 34 includes information (VLANID) of VLANs corresponding to a port number.

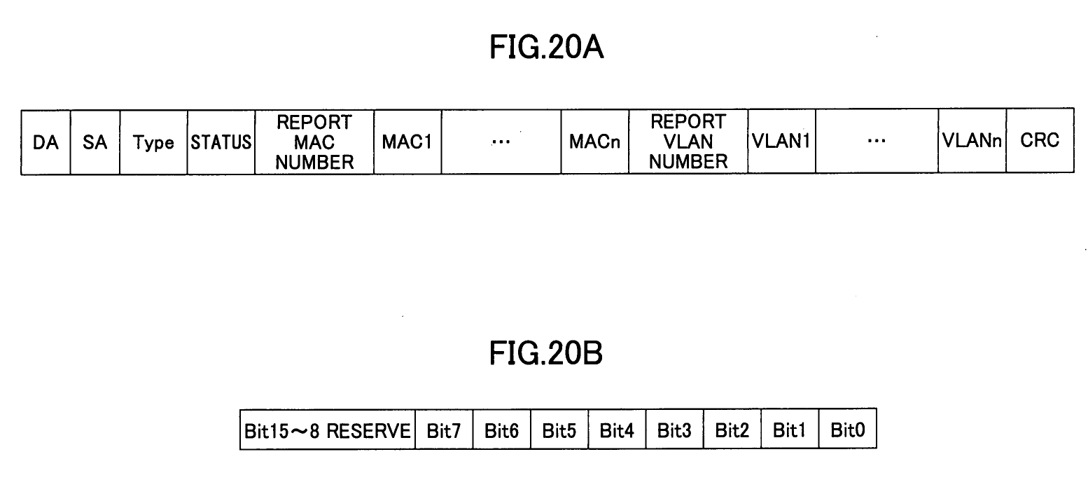

FIG. 20A shows an example of a status report packet for reporting the MAC information and the VLAN information from the switch apparatus 23 to the ADM 21. The status report packet includes a destination MAC address (DA) (ADM MAC address), a source MAC address (SA) (L2SW-A MAC address), an identification type (Type) (identification information indicating status report packet (unassigned Ether Type value=0xf000, for example)), status, a notification MAC number that is a number of MAC addresses learned at the report subject port, the report MAC number of MAC addresses, a report VLAN number that is a number of VLANs accommodated in the report subject port, the report VLAN number of VLAN information of VLANs and error correction code (CRC).

FIG. 20B shows “status” in detail. As shown in FIG. 20B, “status” has 16 bits. In the 16 bits, bits 0-6 indicate the report subject port number, and bit 7=0 indicates normal (no MAC information, and no VLAN information), and bit 7=1 indicates abnormal (there are MAC information and/or VLAN information).

In step S2-4 in FIG. 17, the ADM 21 stores the MAC information and the VLAN information received in step S2-3 in the MAC table 47 and the VLAN table 36 respectively.

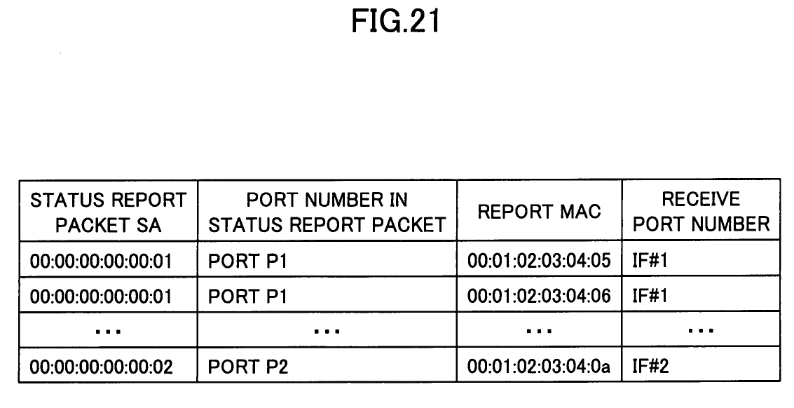

FIG. 21 shows an example of the MAC table 47 of the ADM 21. The MAC table 47 includes a report subject port number in the status of the status report packet, a MAC address learned at the report subject port and a receive port number (interface 38a or 38b) of the ADM 21.

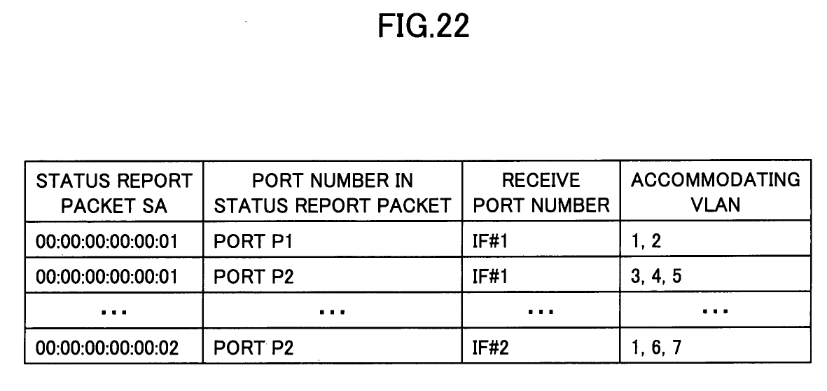

FIG. 22 shows an example of the VLAN table 36 of the ADM 21. The VLAN table 36 includes a report subject port number in the status of the status report packet, a receive port number (interface 38a or 38b) of the ADM 21, and information of accommodated VLANs corresponding to the report subject port in the status report packet.

In step S2-5 of FIG. 17, the ADM 21 receives a packet from the ring network.

In step S2-6, the ADM 21 transmits the packet from the interface 38b when the destination address (DA) of the received packet is set in the MAC table 47 held in step S2-4 or when the received packet is a broadcast packet (BC), a multicast packet (MC) or an unlearned unicast packet (UUC) belonging to a VLAN-ID included in the VLAN table 36. Other packets are transferred in a normal status procedure.

In step S2-7, the packet sent in step S2-6 is received by the switch apparatus 24, and the switch apparatus 24 performs packet transfer according to a learning result of the switch apparatus 24.

In step S2-8, the packet transferred in step S2-7 is received by the switch apparatus 25 and the switch apparatus 27 that accommodates the same VLAN via the transmission lines 20f and 20j respectively.

When the failure of the transmission line 20e is recovered, packet transfer is performed in the following procedure.

In step S3-1, the failure of the transmission line 20e is recovered.

In step S3-2, the switch apparatus that detects the failure recovery of the transmission line 20e return the traffic transmitted over the transmission line 20f back to the transmission line 20e.

In step S3-3, the switch apparatus 23 that detects failure recovery of the transmission line 20e instructs the ADM 21 to delete the MAC information learned on the transmission line 20e and the information of VLANs accommodated in the transmission line 20e.

In step S3-4, the ADM 21 deletes the MAC information and the VLAN information from the MAC table 47 and the VLAN table 36 respectively.

In step S3-5, since information for switching subjects is deleted in the ADM 21 in step S3-4, packet transfer is performed according to steps S1-1-S1-6 for normal status.

As mentioned above, according to the embodiments, a redundancy method in a network including an upper switch apparatus, middle switch apparatuses connected to the upper switch apparatuses via transmission lines and lower switch apparatuses each being connected to the middle switch apparatuses via transmission lines can be provided. In the redundancy method, the upper switch apparatus has link aggregation setting for the transmission lines connected to the middle switch apparatuses, and each lower switch apparatus has link aggregation setting for the transmission lines connected to the middle switch apparatuses, and the upper switch apparatus and one of the lower switch apparatuses switches a traffic route from a transmission line that is failed and that is connected to one of the middle switches to another transmission line for which link aggregation is set with respect to the failed transmission line.

In the redundancy method, a middle switch apparatus of the middle switch apparatuses sets transmission lines connected to the middle switch apparatus to be in a pseudo-failure status when detecting a failure in any one of the transmission lines, so that the upper apparatus and each of the lower switch apparatuses switches a traffic route from a transmission line in the pseudo-failure status to another transmission line for which link aggregation is set with respect to the transmission line in the pseudo-failure status.

In another embodiment, in the redundancy method, when a middle switch apparatus of the middle switch apparatuses detects a failure in a transmission line of the transmission lines connected to the lower switch apparatuses, the middle switch apparatus sends an identifier of a virtual network accommodated in the transmission line in which the failure is detected to the upper switch apparatus, and the upper switch apparatus switches a transmission route of packets corresponding to the identifier from a transmission line by which the identifier is received to another transmission line for which link aggregation is set with respect to the transmission line by which the identifier is received.

Also, in still another embodiment, in the redundancy method, when a middle switch apparatus of the middle switch apparatuses detects a failure in a transmission line of the transmission lines connected to the lower switch apparatuses, the middle switch apparatus sends a learned address that is learned on the transmission line in which the failure is detected to the upper switch apparatus, and the upper switch apparatus switches a transmission route of packets having the learned address as a destination address from a transmission line by which the learned address is received to another transmission line for which link aggregation is set with respect to the transmission line by which the learned address is received.

Also, in still another embodiment, in the redundancy method, when a middle switch apparatus of the middle switch apparatuses detects a failure in a transmission line of the transmission lines connected to the lower switch apparatuses, the middle switch apparatus sends, to the upper switch apparatus, an identifier of a virtual network accommodated in the transmission line in which the failure is detected and a learned address that is learned on the transmission line in which the failure is detected, and the upper switch apparatus switches a transmission route of packets having the learned address as a destination address from a transmission line by which the learned address is received to another transmission line for which link aggregation is set with respect to the transmission line by which the learned address is received, and the upper switch apparatus switches a transmission route of multicast, broadcast or unlearned packets corresponding to the identifier from a transmission line by which the identifier is received to another transmission line for which link aggregation is set with respect to the transmission line by which the identifier is received.

In addition, according to embodiments of the present invention, the upper apparatus and the middle apparatus for the redundancy method can be provided.

As mentioned above, according to the present embodiments, redundancy configuration change from no redundancy configuration to redundancy configuration can be performed easily by a carrier that provides a circuit connection service using switch apparatuses such as layer 2 switches or layer 3 switches. In addition, apparatus redundancy and line redundancy by using link aggregation are realized. Accordingly, addition of end user ports due to addition of edge switch apparatuses can be easily performed while keeping reliability of the network.

The present invention is not limited to the specifically disclosed embodiments, and variations and modifications may be made without departing from the scope of the present invention.

The present application contains subject matter related to Japanese patent application No. 2006-178478, filed in the JPO on Jun. 28, 2006, the entire contents of which are incorporated herein by reference.

What is claimed is:

1. A redundancy method in a network including an upper switch apparatus, middle switch apparatuses connected to the upper switch apparatuses via transmission lines and lower switch apparatuses each being connected to the middle switch apparatuses via transmission lines,
wherein the upper switch apparatus has link aggregation setting for the transmission lines connected to the middle switch apparatuses, and each lower switch apparatus has link aggregation setting for the transmission lines connected to the middle switch apparatuses, and
the upper switch apparatus and one of the lower switch apparatuses switches a traffic route from a transmission line that is failed and that is connected to one of the middle switches to another transmission line for which link aggregation is set with respect to the failed transmission line.

2. The redundancy method as claimed in claim 1, wherein a middle switch apparatus of the middle switch apparatuses sets transmission lines connected to the middle switch apparatus to be in a pseudo-failure status when detecting a failure in any one of the transmission lines, so that the upper apparatus and each of the lower switch apparatuses switches a traffic route from a transmission line in the pseudo-failure status to another transmission line for which link aggregation is set with respect to the transmission line in the pseudo-failure status.

3. The redundancy method as claimed in claim 1, wherein, when a middle switch apparatus of the middle switch apparatuses detects a failure in a transmission line of the transmission lines connected to the lower switch apparatuses, the middle switch apparatus sends an identifier of a virtual network accommodated in the transmission line in which the failure is detected to the upper switch apparatus, and
the upper switch apparatus switches a transmission route of packets corresponding to the identifier from a transmission line by which the identifier is received to another transmission line for which link aggregation is set with respect to the transmission line by which the identifier is received.

4. The redundancy method as claimed in claim 1, wherein, when a middle switch apparatus of the middle switch apparatuses detects a failure in a transmission line of the transmission lines connected to the lower switch apparatuses, the middle switch apparatus sends a learned address that is learned on the transmission line in which the failure is detected to the upper switch apparatus, and
the upper switch apparatus switches a transmission route of packets having the learned address as a destination address from a transmission line by which the learned address is received to another transmission line for which link aggregation is set with respect to the transmission line by which the learned address is received.

5. The redundancy method as claimed in claim 1, wherein, when a middle switch apparatus of the middle switch apparatuses detects a failure in a transmission line of the transmission lines connected to the lower switch apparatuses, the middle switch apparatus sends, to the upper switch apparatus, an identifier of a virtual network accommodated in the transmission line in which the failure is detected and a learned address that is learned on the transmission line in which the failure is detected, and
the upper switch apparatus switches a transmission route of packets having the learned address as a destination address from a transmission line by which the learned address is received to another transmission line for which link aggregation is set with respect to the transmission line by which the learned address is received, and the upper switch apparatus switches a transmission route of multicast, broadcast or unlearned packets corresponding to the identifier from a transmission line by which the identifier is received to another transmission line for which link aggregation is set with respect to the transmission line by which the identifier is received.

6. A middle switch apparatus in a network including an upper switch apparatus, middle switch apparatuses connected to the upper switch apparatus via transmission lines and lower switch apparatuses each being connected to the middle switch apparatuses via transmission lines, the middle switch apparatus comprising:
a failure detection unit configured to detect a failure of a transmission line connected to the middle switch apparatus; and
a pseudo-failure control unit configured to set transmission lines connected to the middle switch apparatus to be in a pseudo-failure status when the failure detection unit detects the failure of the transmission line.

7. An upper switch apparatus in a network including the upper switch apparatus, middle switch apparatuses connected to the upper switch apparatus via transmission lines and lower switch apparatuses each being connected to the middle switch apparatuses via transmission lines, the upper switch apparatus comprising:
a transmission line switching unit configured to receive an identifier of a virtual network accommodated in a failed transmission line from one of the middle switch apparatuses, so as to switch a transmission route of packets corresponding to the identifier from a transmission line by which the identifier is received to another transmission line for which link aggregation is set with respect to the transmission line by which the identifier is received.

8. A middle switch apparatus in a network including an upper switch apparatus, middle switch apparatuses connected to the upper switch apparatus via transmission lines and lower switch apparatuses each being connected to the middle switch apparatuses via transmission lines, the middle switch apparatus comprising:
a failure detection unit configured to detect a failure of a transmission line connected to a lower switch apparatus of the lower switch apparatuses; and
a virtual network identifier reporting unit configured to send an identifier of a virtual network accommodated in the transmission line in which the failure is detected to the upper switch apparatus.

9. A middle switch apparatus in a network including an upper switch apparatus, middle switch apparatuses connected to the upper switch apparatus via transmission lines and lower switch apparatuses each being connected to the middle switch apparatuses via transmission lines, the middle switch apparatus comprising:
a failure detection unit configured to detect a failure of a transmission line connected to a lower switch apparatus of the lower switch apparatuses; and
a learned address reporting unit configured to send a learned address that is learned on the transmission line in which the failure is detected to the upper switch apparatus.

10. An upper switch apparatus in a network including the upper switch apparatus, middle switch apparatuses connected to the upper switch apparatus via transmission lines and lower switch apparatuses each being connected to the middle switch apparatuses via transmission lines, the upper switch apparatus comprising:
a transmission line switching unit configured to receive, from a middle switch of the middle switch apparatuses, a learned address that is learned on a failure detected transmission line, so as to switch a transmission route of packets having the learned address as a destination address from a transmission line by which the learned address is received to another transmission line for which link aggregation is set with respect to the transmission line by which the learned address is received.

11. A middle switch apparatus in a network including an upper switch apparatus, middle switch apparatuses connected to the upper switch apparatus via transmission lines and lower switch apparatuses each being connected to the middle switch apparatuses via transmission lines, the middle switch apparatus comprising:
a failure detection unit configured to detect a failure of a transmission line connected to a lower switch apparatus of the lower switch apparatuses; and
a reporting unit configured to send, to the upper switch apparatus, a learned address that is learned on the transmission line in which the failure is detected and an identifier of a virtual network accommodated in the transmission line in which the failure is detected.
